(19) United States
(12) Patent Application Publication
(10) Pub. No.: US 2010/0013627 A1
(43) Pub. Date: Jan. 21, 2010

(54) SYSTEM AND METHOD FOR MONITORING INFRASTRUCTURE

(75) Inventors: Corey Nicholas Bufi, Troy, NY (US); Steven Hector Azzaro, Schenectady, NY (US); Peter Sam Allison, Conroe, TX (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/175,085

(22) Filed: Jul. 17, 2008

(51) Int. Cl. G08B 1/08; G08B 23/00

(52) U.S. Cl. 340/533; 340/500; 340/539.1

(57) ABSTRACT

A system for generating a threat alert in an infrastructure component is provided. The system includes at least three acoustic sensors disposed at a pre-determined spacing apart from each other on the infrastructure component, wherein each of the sensors is configured to detect a signal corresponding to an outcome that causes damage to the infrastructure component. The system also includes a processing circuitry coupled to each of the at least three acoustic sensors, wherein the processing circuitry configured to filter noise from the signal and generate a threat signal. The system further includes a monitoring center configured to generate a shock alarm in response to the threat signal.

### BACKGROUND

The present invention relates generally to a method and system for securing an infrastructure component such as a pipeline. More particularly, the present invention relates to a method and system for implementing sensor arrangements and gathering data to protect the infrastructure component against potential threats.

In recent years, considerable efforts have been made to secure components of infrastructure such as pipelines and associated oil and gas infrastructure, with financial support from both industry and government. Other examples of infrastructure components include rail lines, waterways, electrical distribution networks, water distribution networks, and so forth. Securing infrastructure components against intentional destructive attacks has been an important focus. However, certain infrastructure components also face threats from third party accidental excavation damages, for example, damage from backhoes or from farmers plowing fields with large machinery, or other machinery used in construction or excavation activities. Providing protection for infrastructures is a complicated task because many components are extremely large and easily accessible.

Traditionally, responses to threats against such infrastructure components have been mostly reactive, mainly because of the enormous amount of resources required to safeguard such infrastructure sites. Ground and aerial patrols have been used, but such patrols have limitations of timely preparedness for responding to a threat effectively. In-person patrolling is not a cost-effective solution, especially where continuous monitoring is considered desirable. Additionally, daily patrolling of pipeline resources has been estimated to be relatively ineffective in terms of actual damage prevention.

Some recent developments in automated pipeline security include the use of geophones, fiber optic cables, satellite surveillance and the like. These solutions have several limitations. One problem is that such sensing methods require highly skilled professionals and sophisticated equipment to deploy them, which limits the level of responsiveness concerned authorities can be to changing threat situations. For example, successful installation, testing, and troubleshooting of fiber optic equipment requires extensive experience with special methods that deal with optical coupling, termination, splicing, and unusual signal complexities. As a result, fiber optic-based system and installation costs can be orders of magnitude higher than non-optical systems. Systems based on geophones must compensate for device sensitivity limitations, requiring the attachment of such devices directly to the infrastructure being monitored. Such processes tends to incur great costs and pose great risk of damaging the monitored infrastructure, with both cost and risk being a function of the number of such devices needed per mile. Satellite surveillance is expensive and is not feasible as a sole method for real time threat detection.

Therefore, there is a need for an improved system and method for detecting threats for components of large infrastructures such as pipelines.

### BRIEF DESCRIPTION

In accordance with one aspect of the invention, a system for generating a threat alert in an infrastructure component is provided. The system includes at least three acoustic sensors disposed at a pre-determined spacing apart form each other on the infrastructure component, wherein each of the sensors is configured to detect a signal corresponding to an outcome that causes damage to the infrastructure component. The system also includes an electronic circuit coupled to each of the at least three acoustic sensors, the electronic circuit configured to filter noise from the signal and generate a threat signal. The system further includes a monitoring center configured to generate a shock alarm in response to the threat signal.

In accordance with another aspect of the invention, a method for manufacturing a threat alert generating system is provided. The method includes providing at least three acoustic sensors disposed at a pre-determined spacing apart on an infrastructure component, wherein each of the sensors is configured to detect a signal corresponding to an outcome that causes damage to the infrastructure component. The method also includes providing an electronic circuit coupled to each of the at least three acoustic sensors, the electronic circuit configured to filter noise from the signal and generate a threat signal. The method further includes providing a monitoring center configured to generate a shock alarm in response to the threat signal.

In accordance with another aspect of the invention, a method for generating a threat alert in an infrastructure component is provided. The method includes detecting a signal corresponding to an outcome that causes damage to the infrastructure component via at least three acoustic sensors disposed at a pre-determined spacing apart on the infrastructure component. The method also includes generating a threat signal based upon the signal detected. The method further includes transmitting the threat signal to a monitoring center.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of a system for generating a threat alert in an infrastructure component in accordance with one embodiment of the invention;

FIG. 2 is a block diagram representation of an exemplary processing circuitry employed in FIG. 1;

FIG. 3 is a flow chart representing steps in a method for manufacturing a threat alert generating system in accordance with one embodiment of the invention; and

FIG. 4 is a flow chart representing steps in a method for generating a threat alert in an infrastructure component in accordance with one embodiment of the invention.

### DETAILED DESCRIPTION

As discussed in detail below, embodiments of the present invention include a system and method for generating a threat alert in an infrastructure component. As used herein, the system and method are employed to identify a source of threat prior to occurrence and further generate a threat alert to prevent resulting potential damages. The source of threat or threat activity includes human initiated events, such as but not limited to, traveling vehicles, land excavation, tunneling, explosive detonations and natural events, such as, but not limited to, earthquakes and land slides.

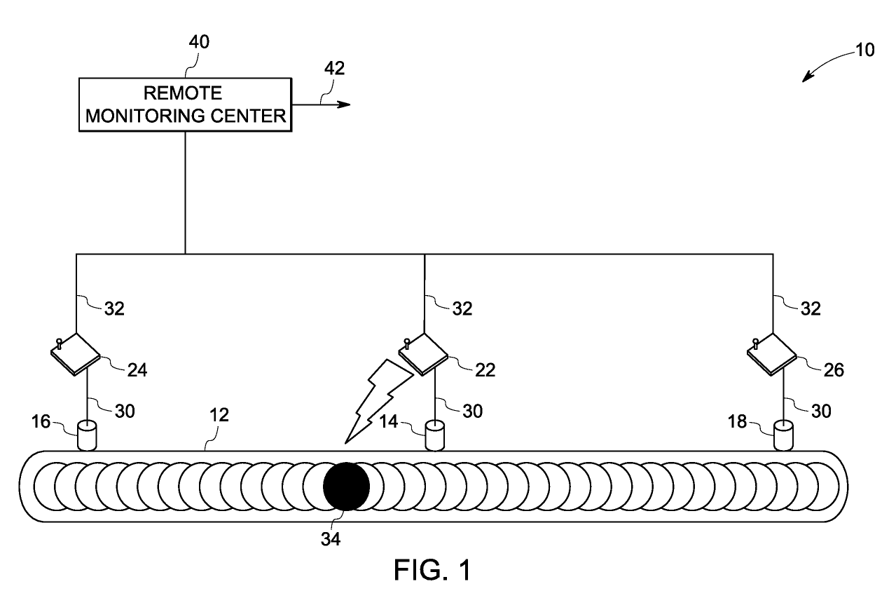

Turning to the drawings, FIG. 1 illustrates a security monitoring system 10 for an infrastructure component that includes, for example, a pipeline 12 that extends for several miles. It will be appreciated that although the pipeline 12 has been illustrated to be linear, it can possess a variety of shapes such as, for example, a circular shape. At least three acoustic sensors 14, 16, 18 are disposed at a pre-determined spacing apart from each other on the pipeline 12. In one embodiment, the acoustic sensors 14, 16, and 18 are spaced at 10 miles apart. It will be appreciated that the pipeline 12 forms an integral part of a sensing network of the security monitoring system 10, since the sensors 14, 16, 18 are disposed within the pipeline 12. The system 10 allows for integration with existing designs of infrastructure components. In a particular embodiment, the acoustic sensors include hydrophones. A processing circuitry 22, 24, 26 coupled to each of the respective sensors 14, 16 and 18 is configured to receive, process and coordinate sensing signals 30 from the sensors. The processing circuitry 22, 24, 26 filters noise from the signals 30 and detects a threat signal 32, in case of a potential threat event 34 corresponding to an outcome that causes damage to the pipeline 12. In a particular embodiment, the processing circuitry includes a beacon box. Once a threat signal 32 is detected, the processing circuitry 22, 24, 26 transmit this data to a remote monitoring center 40 via a communication link that further analyzes the information and generates alerts 42. Some examples of the communication link include wireless networks, hardwire computer data link, a cellular link, satellite communication and wireless sensor-to-sensor communication. An exemplary configuration of the sensors 14, 16 and 18 disposed on the pipeline 12 is illustrated in FIG. 1, wherein the sensor 16 is disposed between the sensor 14 and the sensor 18. In one embodiment, an acoustic triangulation algorithm, well known in the art, is used to precisely determine a location and time of the threat event 34.

In operation, when an acoustic generation event occurs near the pipeline 12, the sensors 14, 16, and 18 sense acoustic signals 30 that are transmitted to the respective processing circuitry 22, 24, and 26. The processing circuitries process the acoustic signals 30 via various software algorithms to determine if there is a threat. In one embodiment, a hybrid detection algorithm is employed. The hybrid detection algorithm distinguishes a threat activity from normal background noise of surrounding environment. As used herein, the term ‘background noise’ refers to acoustic signals generated by incidents such as, but not limited to, traffic noise. In an event of determining a threat, a threat signal 32 is generated that is transmitted to the monitoring center 40. In an exemplary embodiment, in an event of receiving the threat signal from the processing circuitry 22 corresponding to the sensor 14, the monitoring center 40 inspects a sensor preceding the sensor 14 and a sensor disposed immediately after the sensor 14. In the illustrated embodiment, the sensor 16 is the sensor preceding the sensor 14, while the sensor 18 immediately follows the sensor 14. It will be appreciated that, since the pipeline is illustrated to be linear, the sensors 16 and the sensor 18 are disposed to the left hand side of the sensor 14 and the right hand side of the sensor 14. However, in embodiments wherein the pipeline is a shape other than linear, the monitoring center 40 inspects sensors adjacent to the sensor 14 in any direction. A minimum of three sensors are necessary to allow the monitoring center 40 determine a location and time of occurrence of a potential threat event. This approach is also referred to as ‘acoustic triangulation’.

The sensors 14, 16, 18 may form a network for wirelessly communicating with each other. In another embodiment of the invention, the sensors 32, 34, 36, 38 may communicate wirelessly with each other in a pre-defined fashion. In yet another embodiment of the invention, the output of several types of sensors may be combined and/or several sensors may be arranged such that the output of one is input to another. Moreover, the installations of the multiple types of sensors 14, 16, 18 may be permanent in one embodiment of the invention such that these, once installed, remain in the high probability area. In another embodiment of the invention, for instance, the installations of the sensors 14, 16, 18 may be temporary.

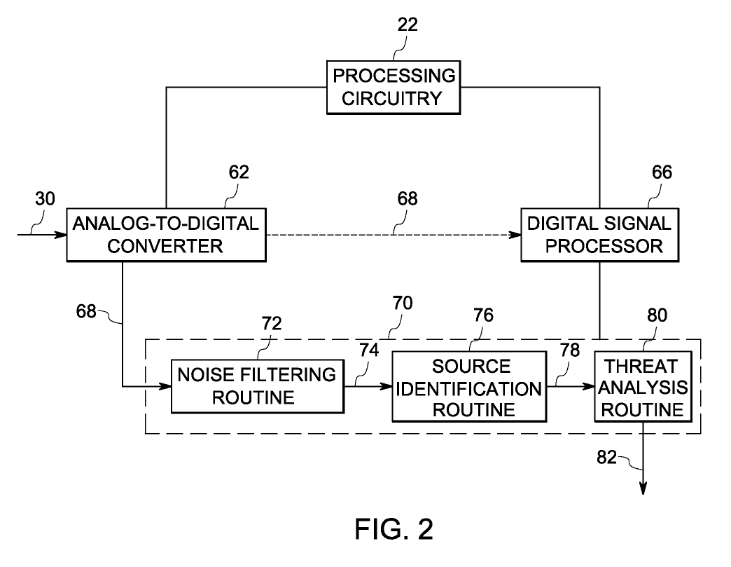

FIG. 2 is a block diagram representation of an exemplary processing circuitry 22 in FIG. 1 that includes at least one analog-to-digital (ADC) converter 62 to digitize sensing signals 64. It will be noted that the illustrated embodiment also applies to the processing circuitries 24 and 26. A digital signal processor (DSP) 66 receives digitized signals 68 and processes the signals 68 in a sequential routine 70. A noise filtering routine 72 filters background noise from the signals 68 and outputs a filtered signal 74 to a source identification routine 76. In one embodiment, the noise filtering routine 72 includes a first filtering path, such as, but not limited to, a Weiner filter and a second filtering path such as, but not limited to, a spectral subtractor. The source identification routine 76 identifies a source generating the signal 74 and outputs a resulting information signal 78 to a threat analysis routine 80, which detects a threat based upon a source identified in the source identification routine 76. The threat analysis routine 80 further generates an alarm, if necessary. Information signal 82 from the threat analysis routine 80 is further transmitted to the remote monitoring center 40, as referenced in FIG, 1. Further details of an exemplary algorithm employed in the processing circuitries can be found in co-pending U.S. patent application Ser. No. 12/054,510 entitled “SYSTEM AND METHOD FOR GENERATING A THREAT ALERT”, filed on Mar. 25, 2008 and assigned to the same assignee as this application, the entirety of which is hereby incorporated by reference herein.

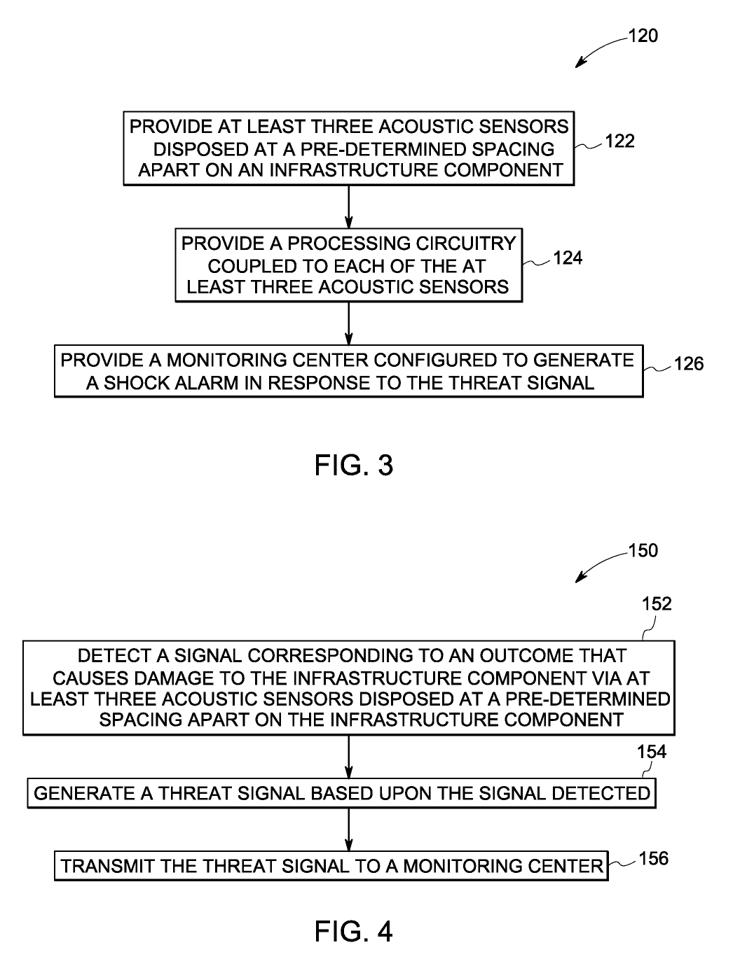

FIG. 3 is a flow chart representing steps in a method 120 for manufacturing a threat alert generating system. The method 120 includes providing at least three acoustic sensors at a pre-determined spacing apart from each other disposed on an infrastructure component in step 122. Each of the sensors is configured to detect a signal corresponding to an outcome that causes damage to the infrastructure component. A processing circuitry coupled to each of the at least three acoustic sensors is provided in step 124. The processing circuitry is configured to filter noise from the signal and generate a threat signal. In one embodiment, a beacon box is provided. In another embodiment, a noise filtering algorithm is provided in the processing circuitry to filter noise from the threat signal. A monitoring center is provided that generates a shock alarm in response to the threat signal in step 126.

FIG. 4 is a flow chart representing steps in a method 150 for generating a threat alert in an infrastructure component. The method 150 includes detecting a signal corresponding to an outcome that causes damage to the infrastructure component via at least three acoustic sensors disposed on the infrastructure component in step 152. A threat signal is generated based upon the signal detected in step 154. The threat signal is transmitted to a monitoring center in step 156. In a particular embodiment, the threat signal is transmitted via wireless communication or wired communication. In one embodiment, a shock alarm is generated in response to the threat signal received. In another embodiment, a location and time of occurrence of the threat signal is determined. In an exemplary embodiment, the location and time of occurrence are determined employing an acoustic triangulation algorithm, as discussed above.

The various embodiments of a system and method for generating a threat alert described above thus provide a convenient and efficient means to prevent damages from occurring within an infrastructure component. The infrastructure component forms an integral component of the system. The technique is engineered to integrate with existing impact detecting infrastructure. Furthermore, range of the sensors are of the order of several miles, implying fewer sensors per mile of coverage, thus lowering cost and complexity of deployment, maintenance, and operation. Furthermore, direct human involvement is eliminated, while providing round the clock surveillance.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an acoustic sensor with a satellite communication link with respect to one embodiment can be adapted for use with an excavation activity using a bulldozer in a protected zone. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for generating a threat alert in an infrastructure component comprising:
at least three acoustic sensors disposed at a predetermined spacing apart from each other on the infrastructure component, wherein each of the sensors is configured to detect a signal corresponding to an outcome that causes damage to the infrastructure component;
a processing circuitry coupled to each of the at least three acoustic sensors, the processing circuitry configured to filter noise from the signal and generate a threat signal; and
a monitoring center configured to generate a shock alarm in response to the threat signal.

2. The system of claim 1, wherein the processing circuitry comprises a beacon box.

3. The system of claim 1, wherein the monitoring center is further configured to determine a time and location of occurrence of the outcome.

4. The system of claim 1, wherein processing circuitry comprises a noise filtering algorithm configured to filter a noise signal from a threat signal.

5. The system of claim 1, wherein the monitoring center is configured to receive the threat signal via a wireless means of communication or a wired means of communication.

6. The system of claim 5, wherein the wireless means comprises satellite, a wireless sensor-to-sensor communication, or a cellular link.

7. The system of claim 5, wherein the wired means comprises a hard wire computer data link.

8. The system of claim 1, wherein the monitoring center is further configured to transmit a message to concerned authority via a communication link.

9. The system of claim 8, wherein the message comprises at least one of a text message or an audio or a video.

10. The system of claim 1, wherein the infrastructure component comprises a pipeline.

11. The system of claim 1, wherein the at least three acoustic sensors are separated at a distance of less than about 10 miles from each other.

12. The system of claim 1, wherein the at least three acoustic sensors comprise hydrophones.

13. A method for manufacturing a threat alert generating system comprising:
providing at least three acoustic sensors disposed at a pre-determined spacing apart on an infrastructure component, wherein each of the sensors is configured to detect a signal corresponding to an outcome that causes damage to the infrastructure component;
providing a processing circuitry coupled to each of the at least three acoustic sensors, the electronic circuit configured to filter noise from the signal and generate a threat signal; and
providing a monitoring center configured to generate a shock alarm in response to the threat signal.

14. The method of claim 13, wherein said providing a processing circuitry comprises providing a beacon box.

15. The method of claim 13, wherein said providing at least three acoustic sensors comprises disposing the sensors at a distance of less than about 10 miles apart from each other.

16. The method of claim 13, wherein providing a processing circuitry comprises providing a noise filtering algorithm to filter noise from the threat signal.

17. A method for generating a threat alert in an infrastructure component comprising:
detecting a signal corresponding to an outcome that causes damage to the infrastructure component via at least three acoustic sensors disposed at a pre-determined spacing apart on the infrastructure component;
generating a threat signal based upon the signal detected; and
transmitting the threat signal to a monitoring center.

18. The method of claim 17, further comprising generating a shock alarm to concerned authority in response to the threat signal received.

19. The method of claim 17, wherein said generating a threat signal comprises filtering noise from the signal detected.

20. The method of claim 17, wherein said transmitting the threat signal comprises transmitting the threat signal via wireless communication or wired communication.

21. The method of claim 17, further comprising determining a location and a time of occurrence of the threat signal.

22. The method of claim 21, wherein said determining comprises employing an acoustic triangulation algorithm.
